(19) United States
(12) Patent Application Publication
(10) Pub. No.: US 2010/0262512 A1
(43) Pub. Date: Oct. 14, 2010

(54) Processing and Presenting Intellectual Property and Other Information

(75) Inventors: Lewis C. Lee, Spokane, WA (US); Daniel L. Hayes, Spokane, WA (US); Brian J. Pangrle, Spokane, WA (US)

Correspondence Address: LEE & HAYES, PLLC, 601 W. RIVERSIDE AVENUE, SUITE 1400, SPOKANE, WA, 99201, US

(73) Assignee: IP Street, Inc., Spokane, WA (US)

(21) Appl. No.: 12/759,619

(22) Filed: Apr. 13, 2010

Related U.S. Application Data
(60) Provisional application No. 61/168,897, filed on Apr. 13, 2009.

(51) Int. Cl. G06Q 10/00; G06F 17/30; G06F 15/16; G06F 3/048; G06Q 30/00

(52) U.S. Cl. 705/26; 707/769; 715/764; 705/310; 705/303; 709/206; 707/E17.014

(57) ABSTRACT

Aggregation, analysis, and presentation of IP-related information and other information are described.

### RELATED APPLICATIONS

This application claims the benefit of U.S. Provisional Application No. 61/168,897, filed Apr. 13, 2009, which is hereby incorporated by reference.

This application is also related to U.S. application Ser. No. 12/730,098, filed Mar. 23 2010, U.S. Provisional Application No. 61/162,998, filed Mar. 24, 2009, PCT Application No. PCT/US2008/7886, filed Oct. 3, 2008, U.S. application Ser. No. 12/245,680, filed Oct. 3, 2008, U.S. Provisional Application No. 60/977,629, filed Oct. 4, 2007, and U.S. Provisional Application No. 60/978,088, filed Oct. 5, 2007. All of these applications are hereby incorporated by reference.

### COPYRIGHT NOTICE

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

### BACKGROUND

Protection of innovation and branding via intellectual property (IP) helps companies convert innovation and branding into business assets. Today, intangible assets represent a significant share of the market capitalizations of many of the most successful and innovative companies. Yet, to the business community and many professionals who are not IP legal experts, intellectual property generally remains somewhat of a mystery to fully understand, assess, and value. Further, issues of counterfeiting and grey market give rise to losses in the billions of dollars a year. Tools to track and understand such issues in the light of IP can bring transparency and significantly increase efforts to the detriment of such illicit activities.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 shows an exemplary system for acquiring and presenting information for an intellectual property document (e.g., intellectual property identification number as assigned by a government agency);

FIG. 2 shows an exemplary graphical display of trademark and related information;

FIG. 3 shows an exemplary system that includes sources of information, analysis of information and modules for presentations and/or alerts aimed at counterfeiting, grey market or other unauthorized or illicit activities;

FIG. 4 shows an exemplary scenario for policing marks with respect to certain activities;

FIG. 5 shows an exemplary system that includes sources of information, analysis of information and modules for presentations and/or alerts aimed at recalls and product defects or misuse and the like;

FIG. 6 shows two sources of information for product recalls along with a product recall news release;

FIG. 7 shows an exemplary scenario for tracking product recalls for a trademarked good or goods;

FIG. 8 shows exemplary graphical user interfaces for tracking trademarks and optionally goods or services associated with the trademarks;

FIG. 9 shows an exemplary method and data for calculation of a tarnishment index (e.g., based on various data and statistics thereof); and

FIG. 10 shows an exemplary user interface for a brand manager or other person (legal, marketing, etc.) for checking a word or words as potential trademarks.

### DETAILED DESCRIPTION

Across the globe, various mechanisms exist for recognizing or granting rights for intangibles such as inventions, creative expressions, symbols of goodwill, etc. Inventions are typically protected using patents, creative expressions are typically protected using copyrights, and symbols of goodwill are typically protected using trademarks (e.g., including trade dress and the like).

Various exemplary techniques described herein integrate Internet data, trademark/copyright data and US Customs data as well as transportation data (which may be acquired publicly or via mechanical turks). As described herein, an exemplary system can make companies become more readily aware of counterfeiting and/or grey market activity; and make US Customs enforcement easier.

An exemplary approach effectively builds a “net of transparency” that coordinates/correlates data to pin-point activity and routes of activity. For example, such a system can track Internet data with respect to time and use this data to hint at sources of illegal activity. For example, on-line auction data from sites like eBay can be used to determine when an item for sale gets posted and where the person or entity selling the item is located. An exemplary approach can also track shipping data for sea, air and land ports based on the regular schedules and observation (e.g., using publicly available information, company information, mechanical turks—to report when a certain ship docks, is unloaded, etc., when a certain plane lands, a train passes, a truck moves).

Based on transportation data and Internet data (eBay and other), an exemplary system can more readily identify transportation routes and where items are entering the US. Once this data is pinpointed, US Customs can more readily seize illegal shipments. Such an exemplary system can address situations where identifying the port of entry is one of the main impediments to effectuating seizure of goods in response to an import alert.

An exemplary system can present an interface that allows a brand manager/IP person, etc., to enter a trademark or copyright and in turn display rich information as to how that trademark or copyright is being used, presented, advertised, etc., around the world.

The aforementioned mechanical turk may be the Amazon Mechanical Turk (MTurk), which is one of a suite of Amazon Web Services, a crowdsourcing marketplace that enables computer programs to co-ordinate the use of human intelligence to perform tasks which, for example, computers are unable to do. Requesters, the human beings that write these programs, are able to pose tasks known as HITs (Human Intelligence Tasks), such as choosing the best among several photographs of a storefront, writing product descriptions, or identifying performers on music CDs. Workers (called Providers in Mechanical Turk's Terms of Service) can then browse among existing tasks and complete them for a monetary payment set by the Requester. To place HITs, the requesting programs use an open Application Programming Interface, or the somewhat limited Mturk Requester site.

Requesters can ask that Workers fulfill qualifications before engaging a task, and they can set up a test in order to verify the qualification. They can also accept or reject the result sent by the Worker, which reflects on the Worker's reputation. Currently, in the Amazon system, a Requester has to have a U.S. address, but Workers can be anywhere in the world. Payments for completing tasks can be redeemed on Amazon.com via gift certificate or be later transferred to a Worker's U.S. bank account. Requesters, which are typically corporations, pay 10 percent over the price of successfully completed HITs (or more for extremely cheap HITs) to Amazon.

Various exemplary methods, systems, devices, described herein relate to intellectual property and information germane to intellectual property, especially for purposes of assessment or valuation of intellectual property and/or tracking movement, advertising, sale, etc., which may be legal or illegal and include counterfeiting and/or grey market activities.

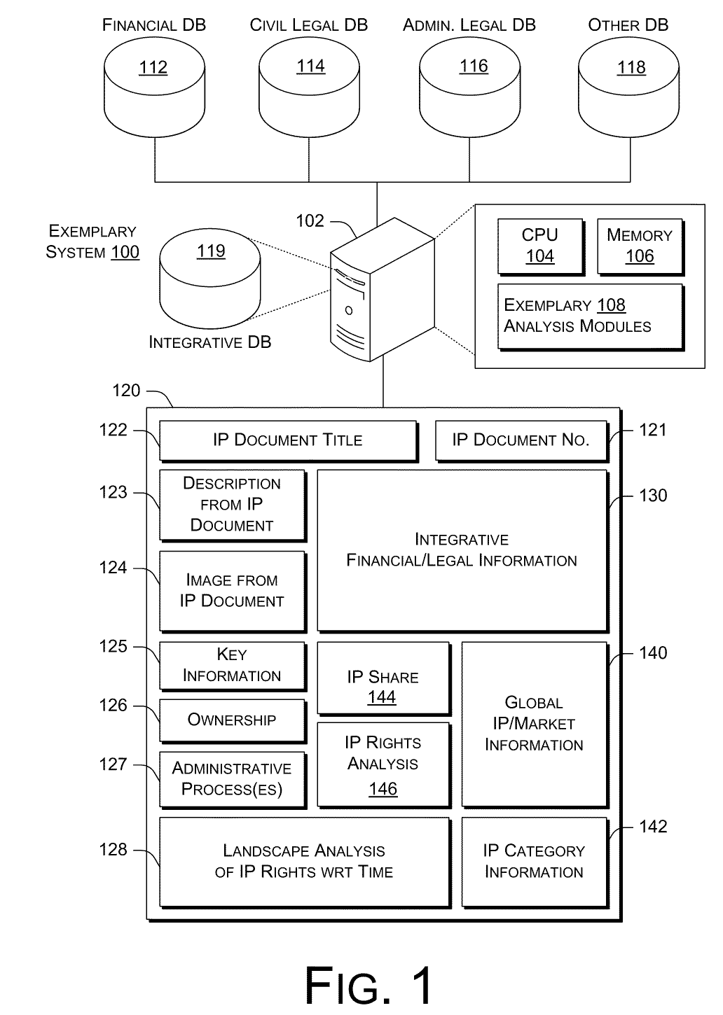

FIG. 1 shows an exemplary system 100 for acquiring and presenting information for an intellectual property document (e.g., intellectual property identification number as assigned by a government agency). The system 100 includes a computing device 102 having a CPU 104, memory 106 and one or more analysis modules 108 for analyzing information. The computing device 102 is representative of a server computing system which may be configured in any number of ways including, for example, as one or more servers (perhaps arranged in a cluster or as a server farm), a mainframe computer, or other server architectures. The computing device 102 may, in certain implementations, represent a site that is accessible over a network, such as website. The memory 106 is representative of a wide range of memory configurations (e.g., volatile and non-volatile memory) and capacities (e.g., disk drives, disk arrays, RAID systems, etc.).

The computing device 102 is configured to access information, such as information in the databases 112, 114, 116, 118, over one or more networks. In the example of FIG. 1, information is available from a financial database 112, a civil legal database 114, an administrative legal database 116 and/or one or more other databases 118. The financial database 112 can provide stock information and optionally other financial information such as options, bonds, etc. In general, such information is available in near real-time along with historic information. The civil legal database 114 can provide information as to litigation. One example database is the PACER database that tracks litigation dockets for both civil and criminal actions for various jurisdictions in the United States, although other legal databases may be used. The administrative legal database 116 is representative of a database associated with an administrative agency. For example, the administrative legal DB 116 may be associated with the US Patent & Trademark Office. While the term “legal” appears in describing the administrative database, an administrative agency may have a database with non-legal information or quasi-legal information as well, which is contemplated herein. Many administrative agencies make determinations as to rights such as patent rights. Other administrative agencies include FDA, FERC, ITC, SEC, US Customs and Border Protection IPRs, and the like. Other databases 118 may include databases of marketing data, country data (e.g., CIA database), etc.

The information collected in the databases may be of domestic or international scope. For instance, the financial DB 112 may represent databases that hold stock and financial information for US companies, or for non-US companies. Further, the administrative legal DB 116 may represent other sources of information, such as European patent information available from the European Patent Office, or Japanese patent information available from the Japanese Patent Office. Essentially, the computing device 102 may draw from any number of US or world based sources of financial, legal, and IP related information. With respect to trademarks, the administrative legal DB 116 may represent, for example, data from the US Patent and Trademark Office's trademark electronic application system (TEAS), trademark application and registration retrieval (TARR) system and/or trademark electronic search system (TESS) databases.

The US Customs and Border Protection (CPB) IPRS is a searchable database containing public versions of U.S. CPB intellectual property rights recordations. Recordations can be retrieved based on simple or complex search characteristics using keywords and Boolean operators. The IPRS database has the added functionality of restricting searches to specific fields and record types. The IPRS database contains expired as well as current records and by default excludes expired records.

The first step in obtaining IPR protection by CBP is to record validly registered trademarks and copyrights with CBP through the Intellectual Property Rights e-Recordation (IPRR) online system. CBP's on-line recordation allows rights owners to electronically record their trademarks and copyrights with CBP, and makes IPR recordation information readily available to CBP personnel, facilitating IPR seizures by CBP. CBP uses this recordation information to actively monitor shipments and prevent the importation or exportation of infringing goods.

As of the end of Fiscal Year 2007, over 21,000 trademarks and copyrights were recorded with CBP. While CBP enforces both recorded and non-recorded trademarks and copyrights, enforcement of recorded trademarks and copyrights takes precedence over those that are not recorded with CBP.

Public versions of trademarks and copyrights recorded with CBP are available in the Intellectual Property Rights Search (IPRS) searchable database.

The trade in counterfeit and pirated goods threatens the innovation economy of various nations, the competitiveness of businesses, the livelihoods of workers, and, in some cases, national security and the health and safety of consumers. The trade in illegitimate goods is associated with smuggling and other criminal activities, and often funds criminal enterprises.

Safety and Security Threats: CBP has targeted and seized an increasing number of counterfeit products that pose safety threats to American consumers, to our infrastructure, and potentially to our security. These products range from electrical articles such as power cords and lights that can catch fire or shock consumers, to batteries that may explode or leak mercury, to personal care items such as toothpaste and shampoo that may contain harmful bacteria, to computer network components and semiconductors that can cripple infrastructure vital for national security.

Strategic Approach to IPR Enforcement: Stopping the flow of fake goods is a priority for the U.S. government, and CBP has designated intellectual property rights (IPR) enforcement as a Priority Trade Issue (PTI). CBP has a strategic approach to IPR enforcement that is multi-layered and includes seizing fake goods at borders, pushing the border outward through audits of infringing importers and cooperation with our international trading partners, and partnering with industry and other government agencies to enhance these efforts. CBP provides considerable resources, diverse personnel and focused training to respond to IPR issues.

IPR enforcement is integrated into the work of several offices throughout CBP. The Office of International Trade develops national IP enforcement policy and initiatives, directs foreign diplomacy, targets shipments of IPR infringing goods, audits infringing importers, and provides training and legal guidance on IPR seizures and penalties. CBP officers and Import Specialist from the Office of Field Operations inspect and seize IPR infringing shipments at ports of entry on a daily basis. Other CBP offices, including the Office of Information and Technology and the Office of International Affairs and Trade Relations, provide valuable expertise in laboratory analysis and provide assistance with foreign diplomacy to further CBP's IPR enforcement mission. CBP internally coordinates IPR strategy through an intra-agency PTI IPR Working Group. This Working Group, which includes representatives from the Office of International Trade (OT), the Office of Field Operations (OFO), the Office of Chief Counsel, the Office of International Affairs and Trade Relations (INATR), the Office of Information Technology (OIT), and U.S. Immigration and Customs Enforcement (ICE), meets on a regular basis to address IPR policy and enforcement issues and to focus the resources of offices throughout CBP.

Domestic Partners in IPR Enforcement: CBP's enforcement is accomplished through the cooperative efforts of trained enforcement officers, other government agencies, and the trade community. CBP coordinates its enforcement efforts with U.S. government trade policy and law enforcement agencies. In addition, CBP works closely with ICE to carry out criminal IPR enforcement actions. As the primary border enforcement agency, CBP is a key player in The Administration's inter-agency Strategy for Targeting Organized Piracy (STOP!).

CBP also works closely with the trade community on IPR enforcement. CBP conducts industry outreach by partnering with rights owners and industry organizations to collaborate on IPR education, and to share information on trends, and where appropriate, on individual cases of suspected IPR infringement. CBP has an on-line recordation system, Intellectual Property Rights e-Recordation, which allows rights owners to electronically record their trademarks and copyrights with CBP, and facilitates IPR seizures by making IPR recordation information readily available to CBP personnel.

International Partners in IPR Enforcement: CBP collaborates with international organizations and foreign governments to enhance IPR border enforcement efforts globally. CBP actively participates in the IPR working groups of several international organizations including the World Customs Organization, the G8, and APEC. CBP also has significant ongoing bilateral efforts. CBP has a memorandum of cooperation with the People's Republic of China to strengthen the enforcement of intellectual property rights laws through exchange of information on seizures and trends, and effective enforcement programs. CBP also is implementing a five point IPR action plan with the European Union, and is partnering with Canada and Mexico through the Security and Prosperity Partnership (SPP) on a strategy to reduce counterfeiting in North America.

Additional Information: More information on CBP's IPR enforcement can be found in CBP's Appendix to the 2008 Report to the President and Congress on Coordination of Intellectual Property Enforcement and Protection, which is incorporated herein by reference.

Another concern is the grey market or gray market, which is often defined as the trade of a commodity through distribution channels which, while generally legal, are unofficial, unauthorized, or unintended by the original manufacturer. In contrast, a black market is typically defined as the trade of goods and services that are illegal in themselves and/or distributed through illegal channels, such as the selling of stolen goods.

The two main types of grey market are imported manufactured goods that would be normally unavailable or more expensive in a certain country and unissued securities that are not yet traded in official markets. Sometimes the term dark market is used to describe secretive, unregulated (though often technically legal) trading in commodity futures, notably crude oil in 2008. This can be considered a third type of “grey market” since it is legal, yet unregulated, and probably not intended or explicitly authorized by oil producers.

Some prescription medications, most notably popular and branded drugs, can have very high prices in comparison to their cost of transport. In addition, pharmaceutical prices can vary significantly between countries, particularly as a result of government intervention in prices. As a consequence, the grey market for pharmaceuticals flourishes, particularly in Europe and along the US-Canadian border where Canadians often pay significantly lower prices for US made pharmaceuticals than Americans do.

Generally regarded as legal in most countries, parallel imports make expensive photographic equipment attractive to savvy users. The grey market in photographic equipment is thriving in highly developed and heavily taxed states like Singapore, with dealers importing directly from lower taxed states and selling at a lower price, creating competition against a local authorized distributor. Grey sets, as colloquially called, are often comparable to authorized imports. Lenses or flash units of parallel imports often only differ by the warranty provided, and since the grey sets were manufactured for another state, photographic equipment manufacturers often offer local warranty, instead of international warranty, which will render grey sets ineligible for warranty claims with the manufacturer. Due to the nature of local warranties, importers of grey sets usually offer their own warranty schemes with reduced benefits or lasting a shorter period of time. Grey sets do not differ particularly from an authorized import. They look and function identically, apart from the manufacturer's warranties having been voided.

Grey market goods may be defined as authentic products that are sold outside their normal chain of distribution. In the realm of luxury goods, an example would be an authentic Louis Vuitton “speedy bag” which is purchased by an individual at a Louis Vutitton retail store while on vacation in the U.S. If the person takes that “speedy bag” and sells it online, on a site like eBay, to a purchaser in a place like London, because of the difference in exchange rates and market conditions, the purchaser in London is able to secure the handbag at a lower cost than buying it new from the Louis Vuitton store.

Sleuthing is one way consumer-goods makers such as Procter & Gamble Co. are fighting back against a growing market for trafficking genuine goods outside of official distribution channels. The practice, known as product diversion, siphons as much as $63 billion of U.S. industry sales, according to Deloitte LLP, the New York-based consulting firm.

Product diversion exploits the different prices manufacturers charge in various parts of the world, said Pat Conroy, head of U.S. consumer products for Deloitte & Touche USA LLP. For example, a distributor might buy a perfume a manufacturer sells for $10 a bottle in Asia, and resell it to a U.S. retailer for $15. The retailer then sells the perfume for $20, undercutting the producer's official U.S. price of $25.

Deloitte estimates a manufacturer with $10 billion in annual sales can lose as much as $450 million to product diversion. That means the practice potentially costs makers of consumer products as much as 4.5 percent of sales in the $1.4 trillion U.S. market for goods ranging from fertilizer to milk to razors, according to Deloitte.

Manufacturers have been dealing with product diversion—also known as the gray market—for at least two decades. The companies can't always take legal action against the practice because the goods are legitimate and not stolen. As a result, they resort to using investigators or other tactics. For example, they may add non-harmful dyes that are restricted in the U.S. or change the packaging on goods destined for overseas locations, giving themselves grounds to sue distributors.

In recent years, the Internet has provided an expanding forum connecting gray market buyers and sellers. The recession also may create a “huge explosion” of trading on the gray market as consumers will be looking for cheaper products, and unemployment in China may lead more people to turn to the gray market for work, he said.

In some cases, manufacturers are succeeding in stopping the distributors. P&G, the maker of Duracell batteries and Hugo Boss fragrances, uses former FBI agents and regulatory, legal and fraud experts to track and halt product diversion. Clorox Co. asks its distributors to sign contracts ensuring that goods arrive only at their designated destinations.

One way P&G, the world's largest consumer-products maker, is fighting back is by developing algorithms to assess order patterns. If a buyer exceeds the amount expected, the Cincinnati-based company may flag the distributor for scrutiny and cut the order.

Steps like these have helped P&G stanch distribution of the most recent Sebastian salon products to unauthorized outlets such as supermarkets and drugstores. The new line, introduced last July, includes Whipped Creme mousse and Trilliant to protect hair against heat and add shine.

When P&G acquired Sebastian in 2004, the product line had a 3 percent share of the retail hair-care market because of diversion. P&G has since dropped more than 150 buyers, and now has less than 1 percent of the market, as measured by Nielsen Co. Of 10 professional hair-care brands tracked, there was a decline only in the diversion of Sebastian products in 2008, according to the Beauty Industry Fund, a trade group.

CVS, the largest U.S. drugstore chain, reportedly buys all of its hair-care products though legitimate channels. Walgreen, the second-biggest, reportedly requires a lot of documentation that the product is authentic and bought legally.

Overall, it's not that difficult to move product from one location to another if the shipping costs warrant it. There are a lot of enterprising people around the world who want to buy low and sell high.

An exemplary system can address such issues through integration of information, especially with respect to time.

The computing device 102 acquires information from the one or more databases 112-118, aggregates the information, and assesses that information via the analysis modules 108. Once processed, the computing device 102 stores the aggregated and analyzed information in an integrative database 119, which allows accessibility to portions or all of the aggregated information.

The computing device 102 is further configured to present the information graphically as indicated by the graphic 120. The graphic 120 may be a printed page or displayed using a display device (e.g., associated with a computer, a terminal, etc.). The graphic 120 consists of a collection of informational items arranged on a page to convey visually certain aspects of the underlying IP asset, such basic information, key statistics, scope of IP rights, and financial information of the asset owner and how the IP related events may impact financial or operational aspects of the asset owner. The graphic 120 may consist of any number of informational items. In certain implementations, the number and arrangement of the items may be configurable by users. For instance, a service hosted on the computing device 102 may allow a user to select from a menu of possible items and arrange those items on the graphic 120. Examples of possible graphics are shown and discussed below. However, these are merely representative, as other graphics may be used to convey the information.

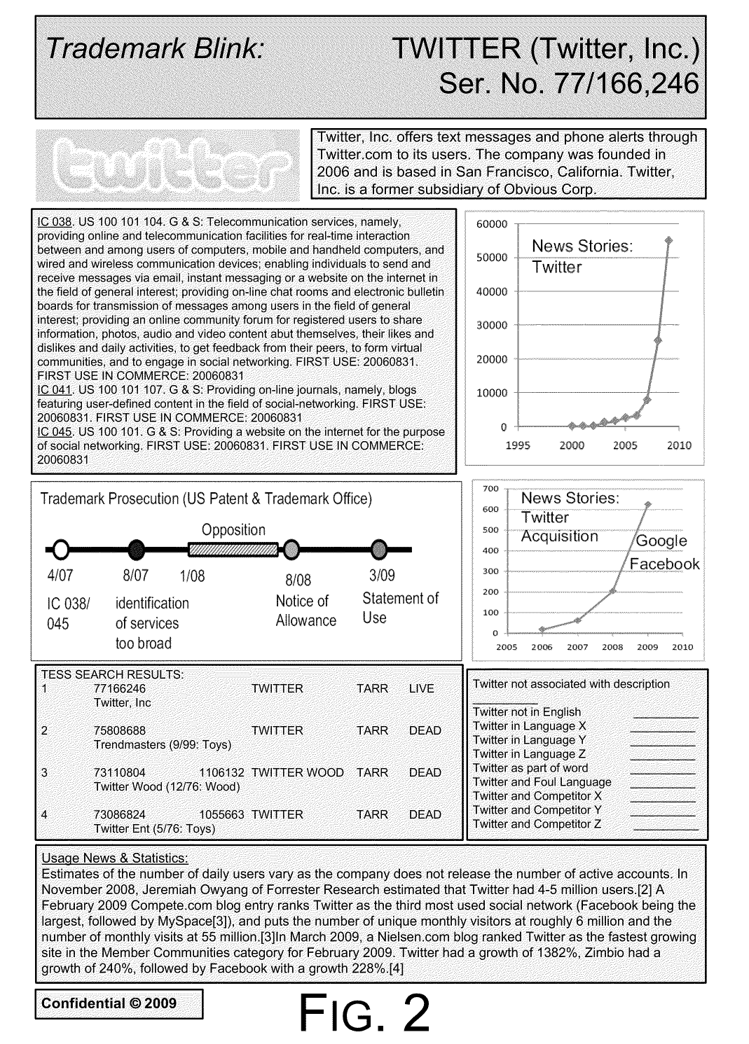

In the example of FIG. 1, the graphic 120 is for an intellectual property document such as a patent or a patent application. In general, such documents have a serial number and/or other identifying number 121. The graphic 120 includes information germane to the document identified by number 121. While a number is stated, the identifier can be letters, numbers, symbols, a combination, and so forth. Also consider that in another example, a trademark serial number and/or other identifying number may be used (see, e.g., FIG. 2).

In the example of FIG. 1, the graphic 120 includes a title 122, a description from the document 123, an image from the document 124, key information from the document 125, ownership information 126, information about administrative proceedings 127, landscape analysis of intellectual property rights or applied for rights with respect to time 128, integrative financial and legal information 130, global IP and/or market information 140, IP classification and/or category information 142, IP share for an owner 144, and IP rights analysis 146. The graphic 120 is provided as an example; other graphics may have less or more information.

In the example of FIG. 1, the title area 122 of the graphic 120 is reserved for the title of the document as well as other general data about the document. For instance, the title area 122 of a graphic generated for a patent document may include the inventor name(s) or the assignee of the patent. For a trademark document, the title area 122 may include the assignee of the trademark or the class of goods and services.

The description 123 may include a brief summary of the asset covered by the IP document. In the case of a patent, the description 123 may be the abstract or summary portion of the document. Alternatively, it may be one of the claims, or selected text from the detailed description section of the patent document. In the case of a trademark, it may be a description of the goods or services.

The image 124 provides a visual of the asset being protected by the IP. For a patent, the image 124 may include an illustration from the patent document, such as one of the figures. For a trademark document, the image 124 may include an image of the mark.

The key information 125 is provided to allow the system administrators to designate certain data for inclusion on the graphic. For a patent document, such key information may include a filing date of the application, an issue date of when the patent issued, a publication date, any priority dates, inventor name(s), the US Examiner who examined the patent application, the law firm handling prosecution of the patent, the class within which the Patent Office classified the invention, a claim count (e.g., total claims, independent claims, etc.), the art unit examining the application, the allowance rate of the art unit, other related patents or applications, key references cited during prosecution, and so forth. Similar information may be provided for other IP assets, such as trademarks and copyright registrations.

The information used to populate the title 122, description 123, image 124, and key information 125 may be retrieved from one or more databases. For instance, much of this information may be found at an administrative legal DB 116 maintained by the US Patent and Trademark Office. Alternatively, this information may be retrieved from other commercial sources, such as services promoted by Thomson®, Lexis/Nexis®, and Google®. As described below, a CBP database may include data associated with intellectual property rights.

The ownership area 126 is provided for a graphic showing the chain of ownership from the time of filing to the present. For an IP document, such as a patent, this area visually depicts assignment data retrieved from the administrative legal DB 116 of the US Patent and Trademark Office.

The administrative process area 127 concerns key data pertaining to how the IP asset was formed. Consider the context of a patent document. When securing a patent, an applicant first files a patent application with the US Patent and Trademark Office, where it is examined. During the examination process, a record is created detailing the Examiner's review of the application and any responsive comments or changes to the patent application made by the applicant. For instance, the Examiner often rejects the initial application on the grounds that the invention as claimed is not novel or is obvious in view of that which is already known in the field of technology. The Examiner cites prior art references and submits arguments as to why the invention as claimed should not be allowed. In response, the applicant commonly submits rebuttal arguments and may on occasions amend the claims to change their scope in an effort to persuade the Examiner that the application should be allowed. This process is called “patent prosecution” and the record created is typically referred to as the “file wrapper history” or simply, “file history”. During this process, the scope of the IP asset may change and this scope change often has an impact on the value of the ultimate IP asset. The USPTO sets forth procedure for patent examination in the Manual of Patent Examining Procedure (MPEP) (see, e.g., Eighth Edition, August 2001, Latest Revision July 2008), which is incorporated herein by reference. Other national, regional or global patent offices have similar manuals.

The USPTO has a similar procedure for trademark examination, as largely set forth in the Trademark Manual of Examining Procedure (TMEP) (e.g, 5th Edition), which is incorporated herein by reference. Other national, regional or global patent offices have similar manuals. A “trademark prosecution history” is available under a document retrieval feature (TDR) that shows contents of a trademark case (e.g., file) and allows for viewing and download of contents. Other features at www.uspto.gov include “Trademark Applications and Registrations Retrieval” (TARR).

The USPTO states that a trademark is a word, phrase, symbol or design, or a combination of words, phrases, symbols or designs, that identifies and distinguishes the source of the goods of one party from those of others. The USPTO states that a service mark is the same as a trademark, except that it identifies and distinguishes the source of a service rather than a product. In general, as described herein, trademark is used to include service mark where appropriate (e.g., noting that a service mark does not generally associate with a product).

Another system for trademarks is known as the Madrid system for the international registration of marks, which was established in 1891 and functions under the Madrid Agreement (1891), and the Madrid Protocol (1989). It is administered by the International Bureau of WIPO located in Geneva, Switzerland.

The international procedural mechanism of the Madrid system offers a trademark owner the possibility to have his trademark protected in several countries by simply filing one application directly with his own national or regional trademark office. An international mark so registered is equivalent to an application or a registration of the same mark effected directly in each of the countries designated by the applicant. If the trademark office of a designated country does not refuse protection within a specified period, the protection of the mark is the same as if it had been registered by that Office. The Madrid system also simplifies greatly the subsequent management of the mark, since it is possible to record subsequent changes or to renew the registration through a single procedural step. Information available via WIPO databases or other databases for trademarks, designs, etc., may be accessed as described herein.

The computing device 102 retrieves the file history (or other administrative record) from the US Patent and Trademark Office (or other appropriate agency) or from a third party supplier. The analysis modules 108 classify and extract key portions of the file history and store them in the memory 106. For instance, in the context of patents, the analysis modules 108 may identify claims, amendments to the claims, arguments made by the Examiner, rebuttal arguments advanced by the applicant, key references, excerpts from those references, pertinent filings or admissions (e.g., terminal disclaimers, information disclosure statements, etc.), reasons for allowance, and so forth. Various forms of analysis (e.g., statistical, semantic, etc.) may be performed on the file history extracts stored in the memory 106 to provide key insights into the formation of the IP asset.

For a trademark, the analysis modules 108 may identify class of goods or services, description, word mark, logo, graphics, specimen, owner, attorney, etc. (e.g., data available using USPTO's TESS, TDR, TTAB database, etc., and similar for jurisdictions outside the United States). Further, Internet searches and/or other databases may provide information. Yet further, Internet statistics may provide information (see, e.g., FIG. 2).

The administrative area 127 provides a graphic that visually conveys to the reader how the IP asset progressed during the administrative period (e.g., during patent prosecution or during trademark prosecution) and how that process may have affected the scope of the IP asset. The graphic is intended to convey at a glance whether the IP assets scope changed significantly or not during the administrative process. Further, it is intended to reveal whether the process involved many interactions with the agency or a few, as a proxy for how clean or messy the file history, which may play a role in whether the asset owner chooses to assert the asset in litigation or offer it for licensing.

The landscape analysis 128 is an area that visually conveys information pertaining to how the IP asset fits within a larger context. The landscape may be directed to technology, or a company's portfolio, or to one or more competitors portfolios, or to a particular geographical region, or to any number of contexts.

The integrative financial/legal information area 130 is provided prominently on the graphic 120, in the upper right hand quadrant. It provides one or more visual cues to correlate certain legal events or transactions with certain financial parameters. In one example, the integrative financial/legal information area 130 includes a stock chart showing the historical stock performance of the company that owns the IP asset over a period of time (e.g., week, month, quarter, year, multiple years, etc.). Overlaid on this chart are indicators showing related legal events, such as litigation events, patent issuance events, settlements, licensing transactions (if known), and so forth. This information is intended to convey whether certain legal events had any impact on the stock performance of the company. It is noted that other financial data and other events may be correlated in this space on the graphic 120 to allow the reader to assess quickly whether there has been a financial impact on the company due to a legal event.

The global IP/market information area 140 is provided to correlate market data with IP-related legal aspects. For instance, in one implementation, the global IP/market information area 140 visually conveys market data about a product being protected, in part, by the corresponding IP asset. As an example, suppose the graphic 120 is for a U.S. patent covering a communications chip used in cell phones. Here, a world map may be shown with different regions of the world color coded to exhibit different cell market growth rates (or penetration rates, or sales figures, or other market data). Correlated with this view is another view of how well the IP asset maps to those regions. In one example, a second world map is juxtaposed with the first one and shows through different colors those regions in which the IP asset is protected by patents. In other implementations, such as those involving an interactive UI, the two world maps may be consolidated, and the user can hover over the various regions to learn whether the market data and whether IP rights for this asset extend to the selected region.

Where brand information represented by a trademark is of concern, various Internet statistics and website information are available as to understand use of a mark, frequency of views or hits, etc.

The IP category information area 142 provides information items pertaining more generally to IP data relevant to IP document. For instance, the area 142 may provide information about the class within which the IP document is assigned (e.g., patent class or trademark class). It may alternatively provide information about the group art unit within which the IP document was examined, or the family tree showing other related IP documents, or IP filing rates in this particular technology worldwide.

The IP share area 144 contains information items derived from analysis of ownership of IP documents within a particular area or class of the IP document being assessed. For instance, this area 144 may provide a breakdown of ownership of the IP documents in a particular class at the US Patent and Trademark Office to which the subject IP document belongs.

The IP rights analysis area 146 is an area reserved for results of an analysis of the scope of rights attached to the IP document. In the context of patents, the scope of a patent document is dictated by the scope of the claims. Thus, the analysis is performed on the claims of the IP documents, and a graphical representation of scope is generated for presentation.

The graphic 120 produced by the system 100 may be used in many contexts. Financial professionals may use the graphic 120 and other higher level analyses to investigate the ties between financial aspects of a company and that company's IP portfolio. IP professionals may use the graphic 120 as a portfolio tool to analyze their own portfolios, as well as others (e.g., competitors, acquisition targets, etc.). IP professionals may further use the graphic 120 in transactions, as well as to assess opportunities in geographical regions or technology sectors.

It is further noted that FIG. 2 presents merely a possible layout and format. The graphic 120 may consist of more or less items than shown in these figures. Moreover, other graphical items may be substituted in place of the ones described and discussed above in the exemplary context.

As described herein, information may be presented in a variety of manners. For example, information may be presented via a web browser interface, a printed page, an electronic document, an active electronic document, a portfolio of documents, etc.

FIG. 2 shows a graphic for the trademark TWITTER. The graphic includes a prosecution timeline and various information related to use of the trademark or more generally the word “twitter”. An analysis block can break out use with respect to categories such as language (e.g., of text on a website), usage, context (e.g., with one or more competitors), etc. Further, graphics of usage data with respect to time may be shown (e.g., news stories, acquisition stories, etc.).

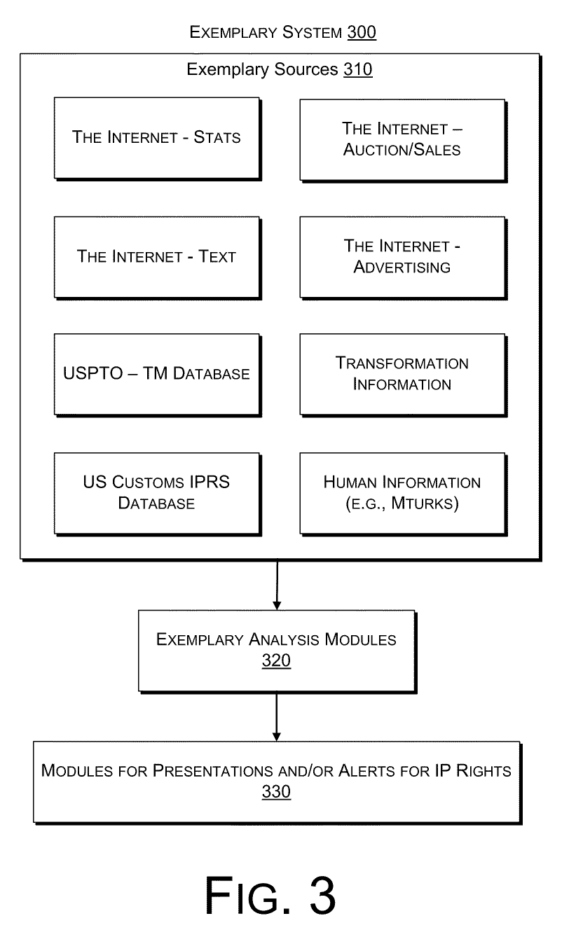

FIG. 3 shows an exemplary system 300 that includes exemplary sources 310, exemplary analysis modules 320 and modules 330 for presentations and/or alerts for IP rights. The exemplary analysis modules 320 analyze acquired information from various of the sources 310 to allow for presentations and/or alerts by the modules 320.

The analysis modules 320 may rely on specialized algorithms such as, but not limited to, Hidden Markov Models, Linear Programming Models, Fuzzy Logic Models, Collaborative Filtering Models, etc. Models may rely on information optionally with respect to time to establish routes of movement, hot spots for activity, etc.

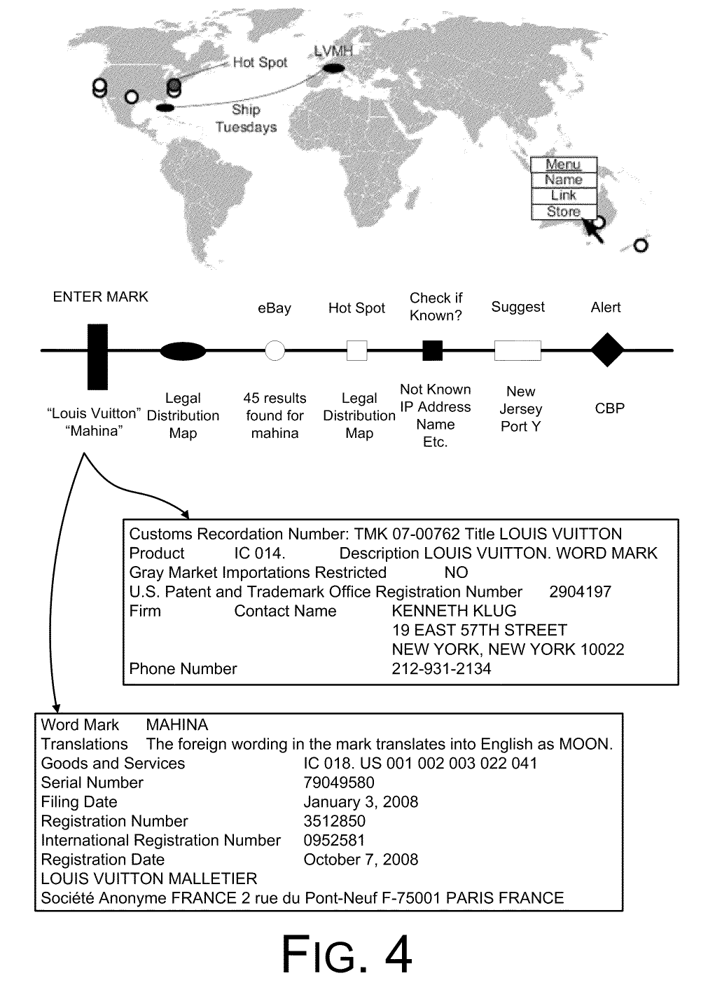

FIG. 4 shows an exemplary graph 400 and an associated timeline 410. A scenario is shown for the marks LOUIS VUITTON and MAHINA. Since the 19th century, manufacture of Louis Vuitton goods have not changed: Luggage is still made by hand. The company manufactures and markets luxury leather goods, fashion accessories, prêt-à-porter, and jewelry. Many of the company's products utilize the signature brown Damier and Monogram Canvas materials, both of which were first used in the late 19th century. All of the company's products exhibit the eponymous LV initials. The company markets its product through its own stores throughout the world, which allows it to control product quality and pricing. It also allows LV to better prevent counterfeit products entering its distribution channels. Louis Vuitton purports to have no discount sales or duty-free stores. In addition, the company purportedly distributes its products through a single online retailer, eluxury.com.

Shipments of merchandise arriving at United States ports must be cleared, or granted entry, by CBP prior to entering the commerce of the United States. The importer obtains clearance through the use of a customs broker, an individual or company licensed by CBP to file entry documents for commercial shipments. The importer presents the customs broker with documents describing the shipment, including bills of lading, invoices and packing lists. Based on this information, CBP may clear a particular shipment, after assessing a duty, without inspecting it. After a shipment is cleared, it may be removed from the port and delivered to the importer or its customer. Counterfeit merchandise will be denied clearance and is subject to seizure.

Shipments of merchandise may also enter the United States temporarily, and without payment of duty, if they are to be delivered to another country. Such shipments require that only CBP-bonded trucks pick up the merchandise at the port and that the shipment be temporarily stored only at a CBP-bonded warehouse.

The exemplary scenario of FIG. 4 commences upon entry of one or more marks, which may be associated as in the example LOUIS VUITTON and MAHINA. The exemplary system accesses information from the USPTO and from IPRS, which provides detailed information about the marks and a recordation at CBP.

Next, the exemplary system accesses legal distribution information, which may be provided by a company or its agents or from another source (e.g., mechanical turk). In the example of FIG. 4, the information indicates shipment on Tuesday from a site in Europe to Miami, Fla.

Next, the exemplary system accesses Internet information pertaining to sales, specifically the auction site eBay. A search is automatically entered using the mark or marks and results analyzed. In this instance, a search performed on the eBay site generated 45 matches. The various sites are then plotted, noting that the plotted sites correspond to actual data. Given a presentation of the sites, a user may quickly identify whether specific sellers are legitimate or not. A user may click on a geographical location and the system may display a menu of options to gather more information or to link directly to the eBay selling site (e.g., to allow for purchase of an item). For example, the location in Australia is shown with a menu that allows a user to see the name of the seller, link to the selling site on the Internet and to store the information to a database, which may optionally occur automatically.

Next, the exemplary system analyzes each of the matches along with geographical information. The system may rank the matches to identify a hot spot. In this instance, the hot spot was found to be in the state of Pennsylvania. For purposes of privacy, the spot is identified a “Allentown” Pa.

Next, the exemplary system compares information acquired from the auction site to information available in one or more databases. For example, other known counterfeiters or grey marketers may be identified and stored in a database. In the example of FIG. 4, a match does not occur.

Whether a match occurs or not, the exemplary system may rely on additional transportation information to track shipments to the specific location (i.e., the seller in Allentown Pa.). The system may further automatically purchase the item and track shipments from the seller and/or to the seller for further information to see if the seller actually possesses the goods at the seller's location or to see if the goods may be shipped from a different location.

As indicated in the example of FIG. 4, the system relies on transportation information and other information about the hot spot to suggest a port of entry for the goods as advertised on the auction site. In this example, the system may rely on various algorithms or a database lookup to suggest Port Y in New Jersey.

Once the port information is provided (e.g., as a suggestion), an alert may be issued to the CBP to allow for more effective enforcement of an import alert for the mark LOUIS VUITTON.

Regardless, of some of the latter steps, the exemplary system may be configured solely to make eBay purchases for the goods that appear in response to entry of the trademark(s). For example, the system may determine which seller on eBay has the highest volume or number of items for sale and then make purchases first from that seller. Once goods arrive, a person may examine the goods to determine whether they are legitimate. Based on such a decision, the person may request that the system take further steps or the person may enter the examination/inspection information in association with details of that seller for storage and later use (e.g., in a learning algorithm, in a database of known violators, etc.).

As an example of CBP seizure, consider that in June 2008, U.S. Customs and Border Protection officers at the El Paso port of entry seized 23 counterfeit handbags for violation of intellectual property rights. The appraised domestic forfeiture value of the handbags was set at $13,573. At that time, this was the second fake handbag seizure made at the Port of El Paso in the last 45 days.

On May 30, 2008 CBP officers working at the Ysleta border crossing intercepted 17 bogus handbags from a U.S. Citizen residing in Fabens, Tex. The Coach, Louis Vuitton, Burberry and Gucci counterfeit purses were seized for violations of U.S. property rights laws.

In the earlier case, a female 47-year-old El Paso resident arrived May 9, 2008 at the Ysleta border crossing. She stated that she had nothing to declare from Mexico. The officer ordered a secondary inspection. In secondary, CBP officers discovered 23 women handbags inside the vehicle. The El Paso resident stated she had forgotten the purses were in the car.

An inspection of the handbags by CBP officers revealed possible IPR violations. The registered trademark intellectual property managers were contacted to provide verification and authenticity of the handbags. More than 150 pictures of the handbags were taken and submitted to owners of the marks. The registered trademark owners confirmed the handbags to be counterfeit.

The global trade in counterfeit or pirated goods is massive. Every year, American businesses lose billions of dollars from the importation and sale of counterfeit goods, and the infringement of copyrights, trademarks and patents. These infringements include counterfeit computer software and games, movies, clothing, jewelry, handbags, shoes and perfumes, watches, and cigarettes.

An exemplary system may include a time control that allows a user to select a time or a time period. For example, a user may maneuver a time slider and a graphical user interface may display various metrics associated with a trademark for a particular time or time period. In such an example, a user may track the number of sellers, sales, etc. for goods associated with a mark. Thus, where this information is displayed graphically with respect to geography, a user may identify trends that may warrant further investigation. For example, as a user moves the slider, a circle located in Allentown PA may grow or shrink based on underlying eBay data for auction items associated with a mark. If the user sees a trend that shows increasing sales, then the user may select an option for further research and analysis of that location and seller.

Further, a time slider or other time plot of information may show spikes in items presented for sale, which may correspond directly to transport of goods to a site or arrival of good (e.g., in the United States). In this example, the seller may be inclined to place items for auction on eBay only when the goods arrive in the United States. If this occurs relatively contemporaneous to arrival of goods, then the time information may be used in conjunction with shipping/transport information to suggest a transport path (e.g., including a port of entry).

Other time slider features are shown and described in the patent application listed above, which are incorporated herein by reference. As described herein, an exemplary time control may allow for display of integrated information for a trademark (e.g., globally) with respect to time.

As described in the example of FIG. 4 an exemplary method, which may be implemented as a module storable in a computer readable storage medium (e.g., for execution by one or more processors), includes entering a trademark(s); pulling TM registration info from USPTO database; pulling TM recordation information from US Customs & Border Protection database; mapping a legal distribution network for trademarked goods; searching eBay for occurrences of the trademark; plotting the seller locations on a map of the world; analyzing the occurrences to determine a geographic hot spot; highlighting the hot spot; analyzing information associated with the hot spot (e.g., database check); suggesting a port of entry for the hot spot; and optionally communicating the port of entry to US Customs & Border Protection (to facilitate seizure of the goods).

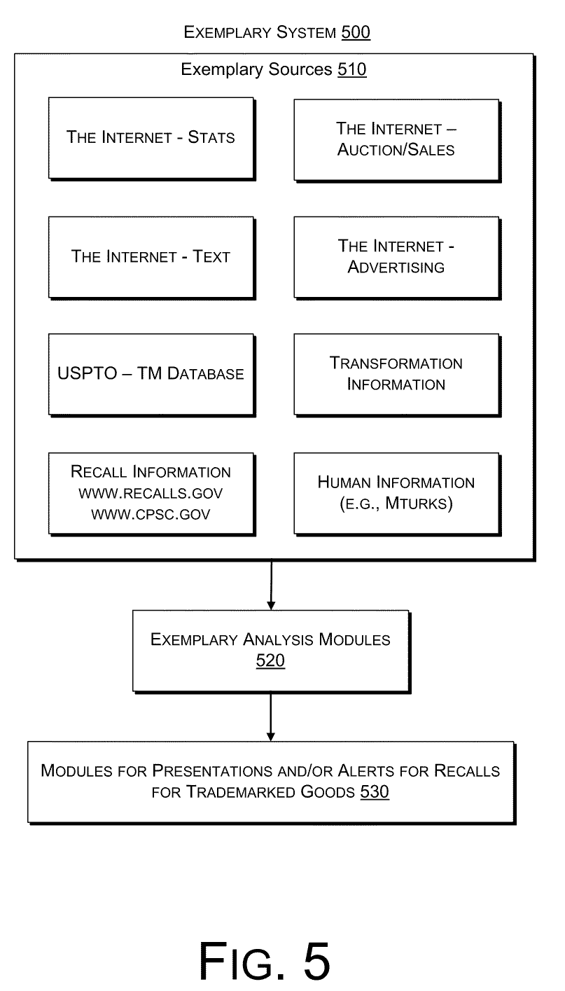

FIG. 5 shows an exemplary system 500 that includes various features of the system 300 of FIG. 3 and a recall information source or sources. Block 530 includes modules for presentations and/or alerts for recalls for trademarked goods.

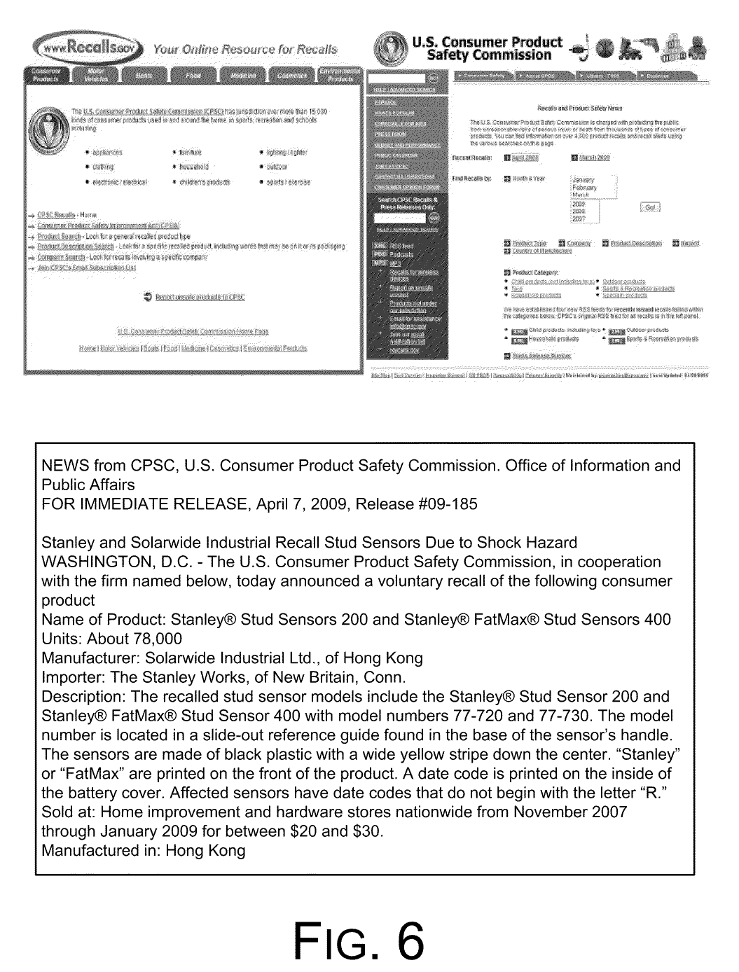

FIG. 6 shows screen shots of the websites www.recalls.gov and http://www.cpsc.gov/cpspub/prerel/prerel.html. Information on these websites may be considered sources of information and suitable for use in the system 500 of FIG. 5.

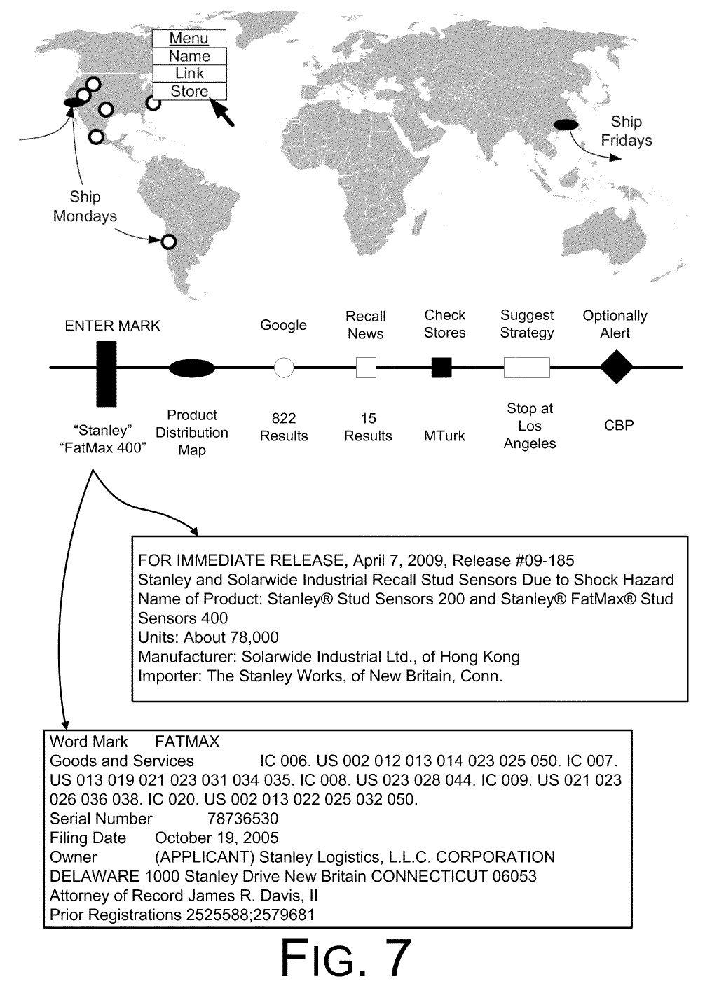

FIG. 7 shows an exemplary scenario for tracking a recall. The scenario commences with entry of a mark or marks, which in this instance includes entry of STANLEY and FATMAX 400.The exemplary system 500 can access information such as recall information and trademark registration information and rely on details therein to determine next steps for a user or to automatically present and guide a user to a suitable conclusion or recommendation.

Where the system 500 is used by a company or other entity with authority to access or knowledge of certain information such as distribution information, the system 500 may rely on such information to better assist the user. As described previously, intelligence data may be gathered in other manners, for example, through use of mechanical turks or the like.

In the scenario of FIG. 7, an Internet search using one or more search engines occurs to determine the number of results for the trademarks. These results may include news results that include the word “recall” in addition to the trademarks.

As an option, store checks may occur in any of a variety of manners. For example, a service may call stores to determine if products have been removed from the shelves. In another example, a mechanical turk process may be implemented to post jobs that include checking certain stores. These tasks may be issued, for example, by activating a control on a user interface that posts information from the Internet searches, the recall information, the trademark information, etc. Specifics as to store addresses and the like may be automatically posted for the jobs to allow the jobs to be performed expeditiously. A lag may be expected as information is gathered, however, information gathered with respect to time may be plotted to allow a user to see graphically and optionally on a map the results of the jobs. Such a visualization may indicate, for example, over a week's time, whether the recall is being adequately effectuated. If the results are not suitable, then the user may take appropriate next steps by mobilizing additional resources to ensure recall of the particular products.

In the scenario of FIG. 7, the system 500 can recommend or suggest a strategy (e.g., stop shipments from port in Los Angeles). As indicated, an alert may also be issued to the CBP for impounding recalled products, which may occur in an amicable and cooperative manner to enhance public safety.

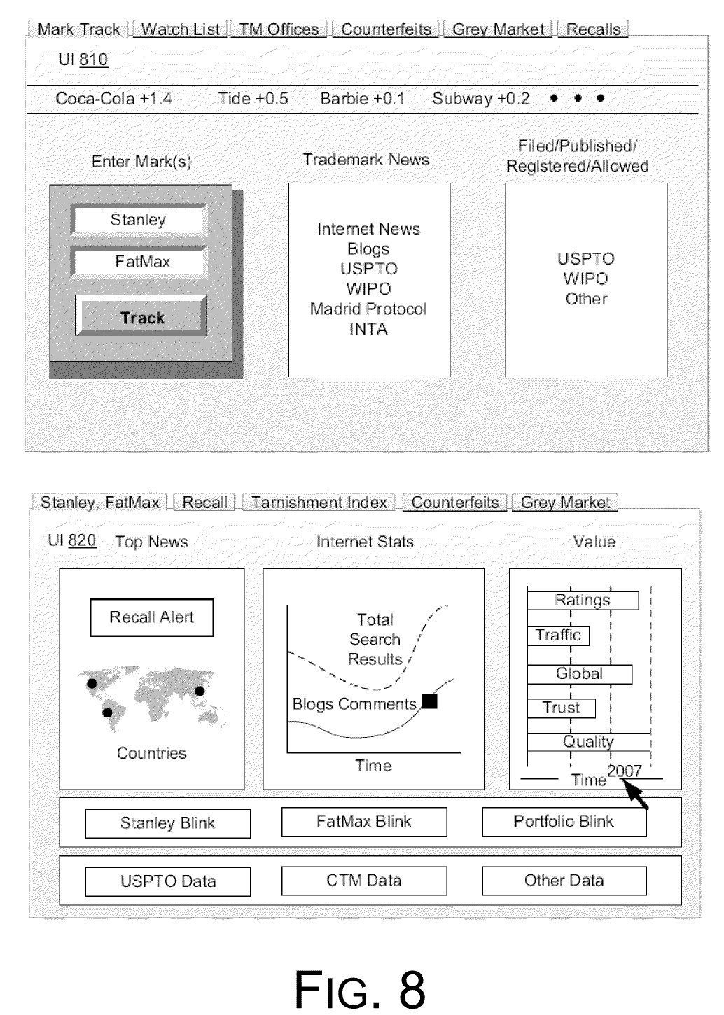

FIG. 8 shows various exemplary graphical user interfaces, which may be implemented (e.g., in part) in CSS or other types of code. The systems 300 and 500 may include such code modules. In the UI 810, a user has an option of selecting a tab for a webpage such as “watch list”, “TM Offices”, “Counterfeits”, “Grey Market” and “Recalls”. The main page shown (UI 810) allows a user to enter one or more marks and to track these marks (e.g., alone or in combination). The UI 810 also includes a ticker that presents information such as an index representative of brand or trademark value, which may be based on a composite of various factors (see, e.g., “value” of UI 820).

In the example of FIG. 8, the UI 810 includes trademark news and information about filed trademarks, published trademarks, registered trademarks, allowed trademarks, etc. This field may track data in the USTPO database to indicate when an opposition period begins and it may also present information as to when a trademark is being opposed, along with information about the opposing party.

After entry of the marks in UI 810, the system 300 or 500 may display the UI 820. In this example, the UI 820 shows top news, Internet statistics, and value. The top news includes a recall alert and countries involved as optionally indicated on a map. The UI 820 may allow a user to click on the map and select a country for further investigation, which may display a UI with appropriate links to pertinent information to understand or effectuate the recall.

The Internet stats may include a total search results metric and a blogs/comments metric with respect to time. Further, an indication of new or blog/comments as being good or bad or important for some particular reason (e.g., an injury to a person) may be provided by markers (see, e.g., black box). The UI 820 may allow a user to select the marker and view the comment, etc., that gave rise to the marker.

The value information may include ratings as in product commentary, traffic as to seller websites and company websites, global information as to global brand recognition, trust as to goodwill in the company (which may be effected by tarnishment of the trademark(s), for example, due to a recall or other event(s)), and quality as to manufacturing standards (e.g., where product is manufactured and historical indications of the manufacturer, where such data is available). The value information shown in FIG. 8 is not limiting but rather exemplary. In the example of FIG. 8, a time control allows a user to select a time and see the value at that point in time. This allows a user to determine trends. Further, the individual metrics of value or a composite value may be plotted with respect to time (e.g., optionally in conjunction with the Internet statistics or other information, such as information for a competitor(s)' trademark(s)).

The UI 820 also includes tabs for “Recall”, “Tarnishment Index”, “Counterfeits” and “Grey Market”. Other information may be optionally integrated into such a UI, for example, advertising or other product information may be integrated (e.g., by an entity where such information may be germane to issues associated with trademarked goods or services).

The UI 820 also includes options to display STANLEY data, FATMAX data, and/or portfolio data (see, e.g., the data of FIG. 2 and various examples presented in the related applications mentioned above). The UI 820 may include controls to access USPTO information for the mark(s), European Community Trademark (CTM) information for the mark(s) and/or other information (e.g., other governmental sources or databases with such information).

The UIs 810, 820 and/or the systems 300, 500 may automatically perform any of a variety of tasks responsive to user input to address counterfeiting, grey market, recalls, etc. For example, with respect to a recall, a system may include one or more processors and control logic operable in conjunction with the one or more processors to access trademark recall information associated with a good or goods, access Internet information for the good or goods that includes geographical information for a seller or sellers of the good or goods, and to present options to effectuate a recall of the good or goods wherein the options comprises one or more of automatically issuing emails, automatically making telephone calls and automatically posting jobs to gather information. The system 300 may operate similarly by issuing appropriate communications with respect to illicit or unauthorized activity.

An exemplary system may optionally link to information associated with anti-counterfeiting solutions or technologies. Some companies use fluorescent nanocrystals (also known as quantum dots) for tracking products. The quantum dots allow manufacturers to trace the source of their materials and manage and track product shipments, helping stop counterfeit material use in pharmaceutical and diagnostic products, food and beverages (and their agricultural and environmental sources), and electronic goods, reducing counterfeiting of currency, documents, fine art, and luxury goods.

Quantum dots are tiny (nanometer size) fluorescent particles. While invisible to the eye, they emit intensely bright light when exposed to low-cost violet or ultraviolet light sources. Quantum dots display unique colors due to differences in size. Due to their particulate nature, quantum dots can easily be blended with polymers, gels, or inks and printed onto most surfaces. The complexity of their manufacturing process also makes them almost impossible to counterfeit. And, because quantum dots are highly stable, extremely bright and absorptive, they offer advancements in solid state lighting, solar collector and electronic display technology. Other technologies include RFIDs.

There are many devices and systems that can be used to authenticate genuine products, but there is no global standard available to help compare the different systems, establish performance criteria or ensure interoperability, according to ISO. An ISO standard would help increase market transparency regarding the reliability and robustness of authentication tools. It would help businesses make an informed choice when selecting the best tools for establishing the authenticity of a product. The standard would also help vendors of anti-counterfeiting systems, whether simple or complex, to improve the solutions they offer. ISO authorities state that “Specifying performance criteria of authentication devices is crucial at both national and international level, to nurture greater confidence among consumers, empower and secure the distribution circuits and help public authorities deploy preventive and punitive measures,” (ISO/PC 246).

The future standard, ISO 12931—Performance criteria for authentication tools for anti-counterfeiting in the field of material goods, will be applicable to all material products. Among the issues to be addressed are: Criteria for data processing; Interoperability of anti-counterfeiting systems; Capacity to facilitate controls; and Authorization of data access, reliability and efficiency to detect counterfeited products, as well as security including tracking. The ISO standard will look at the entire life cycle of a product to facilitate integration of anti-counterfeiting concepts in product design.

An exemplary system may include accessing information associated with the ISO 12931 standard.

According to eBay, Inc., millions of auctions were delisted last year (2008), and tens of thousands of accounts were suspended after reports were made to eBay's Verified Rights Owner program (VeRO), which lets trademark owners notify eBay of fake goods being sold on the site. eBay says 100% of reported listings were removed from the site last year, most within 12 hours, and the company uses sellers' background information to make sure that they don't create new accounts to sell delisted items. Background information is also used to prevent sellers from creating a new profile and re-listing items; eBay reports that 2.1 million listings were removed in 2008 based on VeRO reports, and 30,000 sellers suspended.

An exemplary system optionally includes a selection for legal tasks and another selection for marketing tasks. Further, a legal tasks user interface may include a notification mechanism to issue or display notifications for marketing tasks and actions (and vice versa). Such interfaces can coordinate efforts by legal and marketing professionals, especially procedural tasks (e.g., coordination of specimens for trademark filings, knowledge of new marketing/advertising campaigns and uses of marks).

An exemplary system calculates a metric as to relative strength of a trademark (e.g., optionally using the number of hits in one or more databases such as the USPTO database, Internet searches, etc.). For example, a trademark with multiple owners split across many classes may be considered as having less strength than a trademark with few owners protected across multiple classes. A user interface may display the strength metric as a color on a spectrum from weak to strong (e.g., red to green). Such a mechanism may assist a marketing professional in selection of a suitable trademark. Such a mechanism can render a visual indication of data that would otherwise be time consuming to review (e.g., a list of hits).

Another mechanism may check a trademark against a class of goods or services and dictionary definitions and indicate whether the selected trademark (e.g., word) is generic, descriptive, suggestive, fanciful or arbitrary. In general, trademark distinctiveness is an important concept in the law governing trademarks and service marks. A trademark may be eligible for registration, or registerable, if amongst other things it performs the essential trademark function, and has distinctive character. Registerability may be understood as a continuum, with “inherently distinctive” marks at one end, “generic” and “descriptive” marks with no distinctive character at the other end, and “suggestive” and “arbitrary” marks lying between these two points. An exemplary user interface may include a distinctiveness metric. A user interface may display the distinctiveness metric as a color on a spectrum (spectrum of distinctiveness as described by some courts) from less distinctive to more distinctive (e.g., red to green). Such a mechanism may assist a marketing professional in selection of a suitable trademark. Such a mechanism can render a visual indication of data that would otherwise be time consuming to review (e.g., dictionaries, etc.).

Where logos are submitted as specimens, an exemplary system includes an image analysis module that can analyze images (e.g., filtering, edge detection, etc.). Such a module may classify images based on certain characteristics and optionally compare images based on such characteristics. An exemplary system downloads images from a trademark database (e.g., USPTO) and analyzes the images and stores the characteristics in conjunction with metadata about the trademark. A user optionally creates a dataset of images (or image characteristics) to compare against downloaded images (or otherwise analyzed images or image characteristics). Where a suitable match occurs (e.g., number of edges and layout of edges such as proportions, etc.), the system may issue an alert. This mechanism allows a user to become aware of potentially confusing marks that may encroach or dilute an existing mark. Various conventional algorithms for image analysis are available to extract characteristics and make comparisons.

An exemplary system allows a user to select or enter a word as a potential or actual trademark and to have the word translated into one or more other languages. For example, the word MAHINA translates to “moon” (e.g., Hawaiian). The system may include a module that shows a map of the world and highlights regions where the word has a ready translation. The system may include a module that determines a metric as to “translatability” of the word as a potential trademark. The translatability metric may be for a select language or region. For example, a user may select one or more languages or regions and then enter a word. The module may indicate translatability, which can then be viewed as favorable or unfavorable by the user. An exemplary system may also access trademark data for one or more translations (e.g., in a USPTO or foreign database of trademark information).

An exemplary system allows a user to select or enter a word as a potential mark and to have a search performed for a domain name or domain names. An exemplary metric may indicate along a spectrum an ability to acquire a domain name that includes the word. For example, a user may enter a word, in turn, the system searches one or more sources for availability of a domain name(s) that include the word. If the word by itself is available as, for example, a word.com, then a green graphic may appear; whereas, if the word is not available alone and the word appears in many combinations (e.g., not available in many different forms), then a red graphic may appear on a user interface.

An exemplary system optionally displays information as to renewals, affidavits of use, etc., optionally in conjunction with geography and optionally in conjunction with use data (e.g., as evidence), which may be required to accompany or verify legal requirements or support an affidavit by a person filing a statement or taking other action. Such a system may display such information for a portfolio with a forward looking window of years. A user may optionally select a time frame or date to determine what may be due within that time frame, what has been completed, etc. An exemplary system may recognize automatically opportunities to harmonize procedures in multiple jurisdictions and/or for multiple marks (e.g., to reduce costs).

Relevant trademark related information may include: Relevant trademark related data may include application information such as application date, application number, publication date of application; registration information such as registration date, registration number, publication of registration, applicant/registered owner, priority date, information on seniorities; trademark type such as word mark, device mark, 3D mark, sound mark, color mark; trademark image; classes of goods and services including list of goods and services; agent information; financial information such as costs per trademark/costs per department, costs per country/cost of agents to determine financial balance; assignment information/change of name; deadlines (external terms) such as renewal date, priority period, due date for foreign filing (priority), official action deadline; tasks (internal terms) such as follow-up, reminders; use information such as use requirement date, actual use information; related documents such as registration certificates, agreements, licenses, use documentation.

An exemplary system may optionally access relevant contractual data and other relevant terms and conditions, such as affected trademark rights, contracting parties, expiration date, termination date, payment periods, information on current and closed files, cross-references to related proceedings such as litigation proceedings, opposition proceedings, or negotiations.

An exemplary system may include an ability to issue reports (see, e.g., the TWITTER trademark blink report). Internal data may supplement a report, for example, to show licensing of a trademark.

While litigation events may be shown on a user interface that includes information about a trademark, other types of events may be shown as well (e.g., oppositions). Further, an exemplary system may provide indications of when an opposition period opens and/or closes and whether any party has filed an opposition as well as notify a disposition to a filed opposition. Such information may be shown in conjunction with a variety of data, include, for example, share price, a trademark metric (e.g., as to value), etc.

An exemplary system may include mechanisms to monitor dilution and/or tarnishment. For example, an Internet search may uncover dilutive text and/or text with terms that would tarnish the mark. As described herein, such searches may occur automatically upon entry of a mark or access to a “watch list” of marks where the data is analyzed and plotted with respect to historical metrics to allow a user to determine whether dilution and/or tarnishment are trending up/down, etc. Such a system may further group the occurrences to provide a user with indications as to one or more sources of dilution/tarnishment. Further, the system may rank multiple sources as to offensiveness and/or compare to historical data to track repeat offenders. An exemplary system optionally issues alerts when a particular offender is found to be a source. Further, an exemplary system may allow a user to set a threshold or set point that issues an alert when the number of instances of prospective dilution and/or tarnishment exceeds the threshold or set point.

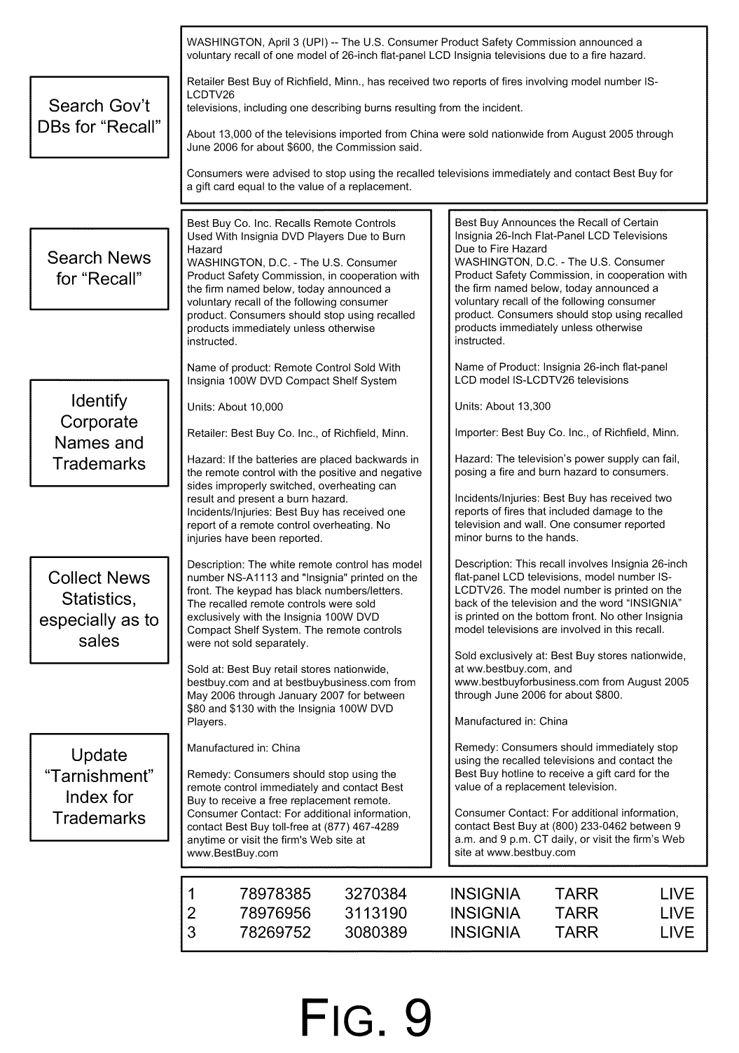

FIG. 9 shows an exemplary method and data that may be used in calculating a tarnishment index for a trademark (e.g., INSIGNIA). In this instance, recall information, news and trademark information may be used (e.g., to determine dates, products, etc., that indicate severity of tarnishment). For example, if the news indicates that human injury has occurred then a tarnishment index may weight this heavily and a user interface may display a score and/or a graphical indicator (color, size or other) as to tarnishment of the mark. A dilution index may operate similarly but rather rely on information as to dilution.

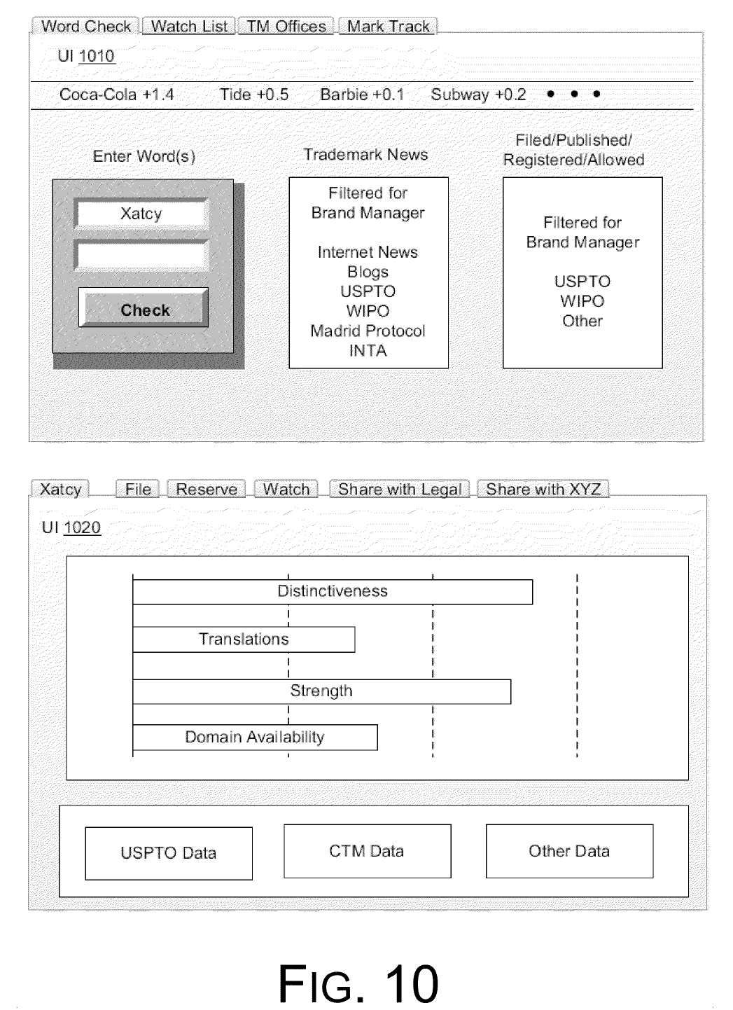

FIG. 10 shows an exemplary user interface 1010 and an exemplary user interface 1020 for checking a word as a potential trademark. The UI 1010 shows filtered news for a brand manager and filtered trademark information for a brand manager. Thus, the UI 1010 may be considered a brand manager trademark dashboard. Options include “Mark Track” that could show a UI such as the UI 810 of FIG. 8. The UI 1020 shows results for the word “Xatcy”, particularly, distinctiveness, translations, strength and domain availability. Such information may be displayed in the UI 1010 (e.g., to allow for ready entry and display of results to speed word checking). A user may optionally click on any of the bars and see additional information for a metric.

The article “Marketing strategy and market value: An event-study analysis, European Management Journal, Volume 16, Issue 3, June 1998, Pages 365-371” is incorporated herein by reference. The Abstract states: Clearly, managers must take into consideration the possible effect of their marketing strategies on the value of the firm. Charles Pahud de Mortanges and Alireza Tourani Rad use event-study analysis to test the hypothesis that the stock market value of a firm can be negatively affected by bad publicity related to a marketing strategy. Specifically, the authors explore the effect of the introduction, bad publicity and subsequent recall and modification of a major brand of laundry detergent in The Netherlands, Omo Power, on the stock price of its manufacturers, Unilever. It is concluded that the marketing strategy itself was flawed.

As described herein, various events may be shown with respect to a plot of share price and/or options prices. A sensitivity metric may correlate movements in price with respect to events germane to intellectual property (see, e.g., related patent applications listed above as to price and patent litigation events).

Various exemplary methods may be optionally embodied, in whole or in part, as instructions on a computer-readable medium.

What is claimed is:

1. A system comprising:
a processor and memory; and
control logic stored in the memory and executable on the processor to:
access trademark information associated with a good;
access sales information for the good that includes geographical information for a seller of the good;
analyze the sales information and the geographical information; and
suggest a port of entry of the good based at least in part on the geographic information for the seller.

2. The system of claim 1, wherein the sales information comprises online auction information of the good associated with the trademark information.

3. The system of claim 2, wherein accessing the sales information comprises automatically conducting a search on one or more online auction sites for goods associated with the trademark information.

4. The system of claim 3, wherein analyzing the sales information and the geographical information comprises identifying locations of sellers of the goods, and determining based on the locations whether the sellers of the goods are legitimate.

5. The system of claim 1, wherein the trademark information comprises information for recordation of a trademark with U.S. Customs and Border Protection.

6. The system of claim 1, wherein the control logic is further executable to communicate the suggested port of entry to a party responsible for policing the trademark.

7. The system of claim 6, wherein the party responsible for policing the trademark comprises a law firm, a company, or a government agency.

8. A system comprising:
a processor and memory; and
control logic stored in the memory and executable on the processor to:
access trademark recall information associated with a good or goods;
access Internet information that includes geographical information for a seller or sellers of the good or goods; and
present options to effectuate a recall of the good or goods.

9. The system of claim 8, wherein the options to effectuate a recall of the good or goods comprise:
automatically issuing emails;
automatically making telephone calls; and/or
automatically posting jobs to gather information.

10. A system comprising:
a processor and memory; and
control logic stored in the memory and executable on the processor to:
receive entry of a word;
access data based on the received word;
determine one or more metrics germane to use of the word as a trademark; and
display the one or more metrics graphically.

11. The system of claim 10, wherein the one or more metrics include:
a translation metric indicating whether translations exist for the word in other languages;
a distinctiveness metric indicating a relative distinctiveness of the word;
a strength metric indicating an estimate of a relative strength of a trademark using the word; and/or
a domain availability metric indicating an availability of domain names using the word.

12. The system of claim 10, wherein the data comprises dictionary data and data from a trademark database.

13. One or more computer-readable media storing computer-executable instructions that, when executed, configure a processor to perform acts comprising:
presenting, on a display, a graphic including trademark-related information;
presenting, on the display, a time control usable to select a time;
receiving an input to the time control indicating a selected time; and
updating the graphic, based at least in part on the selected time input to the time control, to show trademark-related information associated with the selected time.

14. The one or more computer-readable media of claim 13, wherein the trademark-related information comprises information regarding use of a trademark on websites and/or in articles.

15. The one or more computer-readable media of claim 13, wherein the trademark-related information comprises a tarnishment index indicating a degree to which a trademark has been tarnished by an event.

16. The one or more computer-readable media of claim 13, wherein the trademark-related information comprises a dilution index indicating a degree to which a trademark has been diluted.

17. The one or more computer-readable media of claim 13, wherein the graphic comprises a map configured to display trademark-related information relative to a geographic area.

18. The one or more computer-readable media of claim 13, the acts further comprising establishing routes of movement and/or hot spots of activity relating to goods associated with the trademark-related information, based at least in part on analysis of the trademark-related information over time.

19. The one or more computer-readable media of claim 13, the acts further comprising obtaining the trademark-related information from a database prior to presenting the information on the display.

20. The one or more computer-readable media of claim 13, the acts further comprising:
accessing trademark information associated with a good;
accessing sales information for the good that includes geographical information for a seller of the good, the on-line sales information comprising online auction information;
analyzing the sales information and the geographical information;
suggesting a port of entry for the good with respect to the seller; and
communicating the suggested port of entry to a party responsible for policing the trademark, wherein the party comprises a law firm, a company or a government agency.

21. The one or more computer-readable media of claim 20, the acts further comprising:
accessing trademark recall information associated with a good or goods;
accessing Internet information that includes geographical information for a seller or sellers of the good or goods; and
presenting options to effectuate a recall of the good or goods, the options comprising:
automatically issuing emails;
automatically making telephone calls; and/or
automatically posting jobs to gather information.

22. The one or more computer-readable media of claim 21, the acts further comprising:
receiving entry of a word;
accessing data based on the received word;
determining metrics germane to use of the word as a trademark; and
displaying the metrics graphically.

23. The one or more computer-readable media of claim 22, wherein the one or more metrics include:
a translation metric indicating whether translations exist for the word in other language;
a distinctiveness metric indicating a relative distinctiveness of the word;
a strength metric indicating an estimate of a relative strength of a trademark using the word; and/or
a domain availability metric indicating an availability of domain names using the word.
